(19) United States
(12) Patent Application Publication
(10) Pub. No.: US 2025/0047403 A1
(43) Pub. Date: Feb. 6, 2025

(54) Methods and Network Devices for PTP Clock Synchronization

(71) Applicant: Telefonaktiebolaget LM Ericsson (publ), Stockholm (SE)

(72) Inventors: Yao PENG, Beijing (CN); Binggang SONG, Beijing (CN)

(73) Assignee: Telefonaktiebolaget LM Ericsson (publ), Stockholm (SE)

(21) Appl. No.: 18/718,440

(22) PCT Filed: Dec. 22, 2021
(86) PCT No.: PCT/CN2021/140571

§ 371 Date: Jun. 11, 2024

(51) Int. Cl. H04J 3/06; H04L 45/24

(52) U.S. Cl. CPC H04J 3/0667; H04L 45/245

(57) ABSTRACT

Methods and network devices are disclosed for precision time protocol (PTP) clock synchronization. According to an embodiment, there is a link aggregation group (LAG) between a first network device acting as a PTP slave and a second network device acting as a PTP master. The first network device obtains, for a first LAG member of the LAG acting as a first path from the PTP master to the PTP slave in an exchange of PTP messages for clock synchronization, a delay value reflecting an additional propagation delay of the first LAG member relative to a reference LAG member of the LAG. The first network device obtains, for a second LAG member of the LAG acting as a second path from the PTP slave to the PTP master in the exchange of the PTP messages, a delay value reflecting an additional propagation delay of the second LAG member relative to the reference LAG member. The first network device compensates an asymmetry between propagation delays of the first path and the second path, based on the delay value of the first LAG member and the delay value of the second LAG member.

### TECHNICAL FIELD

Embodiments of the disclosure generally relate to communication, and, more particularly, to methods and network devices for precision time protocol (PTP) clock synchronization.

### BACKGROUND

This section introduces aspects that may facilitate better understanding of the present disclosure. Accordingly, the statements of this section are to be read in this light and are not to be understood as admissions about what is in the prior art or what is not in the prior art.

The institute of electrical and electronics engineers (IEEE) 1588 version 2 (V2), also known as precision time protocol (PTP), is an industry-standard protocol that enables the precise transfer of frequency and time to synchronize clocks over packet-based Ethernet networks. It synchronizes the local slave clock on each network device with a system grandmaster (GM) clock and uses traffic timestamping, with sub-nanoseconds granularity, to deliver the very high accuracies of synchronization needed to ensure the stability of base station frequency and handovers. Timestamps between master and slave devices are sent within specific PTP packets and in its basis form the protocol is administration-free.

According to IEEE1588v2, BC is a boundary clock with multiple PTP ports connecting to multiple GMs. One of them may be “Slave” state, and the remaining PTP ports should be “Passive” or “Master” state, which is decided by best master clock algorithm (BMCA). The “Slave” port will have higher priority to calibrate the frequency and time from received timestamped packets. The frequency and time will be delivered to downstream clock via the “Master” ports.

The international telecommunications unit-telecommunication (ITU-T) G.8275.1 profile defines a specific architecture to allow the distribution of phase/time with full timing support network. The ITU-T G.8275.2 profile defines a specific architecture to allow the distribution of phase/time with partial timing support (PTS) from the network. These profiles are all based on the PTP defined in IEEE1588v2.

FIG. 1 illustrates a PTP message exchange procedure. Suppose that: Offset is the offset between the slave clock and the master clock, i.e. Offset=t_{Master}−t_{Slave}; t1 is the timestamp at which the Sync message is sent from the master; t2 is the timestamp at which the Sync message is received by the slave (note that t2 may be carried by the Sync message or the Follow-up message); t3 is the timestamp at which the Delay_Req (or Delay Request) message is sent from the slave; t4 is the timestamp at which the Delay_Req message is received by the master; Master_to_slave_delay (or D-ms) is the propagation delay from the master to the slave; and Slave_to_master_delay (or D-sm) is the propagation delay from the slave to the master. Then, the following two equations can be obtained:

$$t 2 - t 1 = D - ms + Offset , \qquad ( 1 )$$

$$t 4 - t 3 = D - ms - Offset . \qquad ( 2 )$$

Supposing D-ms=D-sm=Delay, PTP can use the sent timestamps (t1, t3) and received timestamps (t2, t4) to calculate the Offset and Delay, and recover the clock from the master (e.g. a GM), as shown below.

$$Delay = ( t 2 - t 1 + t 4 - t 3 ) / 2 , \qquad ( 3 )$$

$$Offset = ( t 2 - t 1 - delay ) = [ ( t 2 - t 1 ) - ( t 4 - t 3 ) ] / 2 , \qquad ( 4 )$$

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for PTP clock synchronization. In particular, one of the problems to be solved by the disclosure is that the existing solution for PTP clock synchronization could not work well in the case where a link aggregation group (LAG) is between the master and slave devices.

According to a first aspect of the disclosure, there is provided a method performed by a first network device. There is an LAG between the first network device acting as a PTP slave and a second network device acting as a PTP master. The method may comprise obtaining, for a first LAG member of the LAG acting as a first path from the PTP master to the PTP slave in an exchange of PTP messages for clock synchronization, a delay value reflecting an additional propagation delay of the first LAG member relative to a reference LAG member of the LAG. The method may further comprise obtaining, for a second LAG member of the LAG acting as a second path from the PTP slave to the PTP master in the exchange of the PTP messages, a delay value reflecting an additional propagation delay of the second LAG member relative to the reference LAG member. The method may further comprise compensating an asymmetry between propagation delays of the first path and the second path, based on the delay value of the first LAG member and the delay value of the second LAG member.

In this way, the asymmetry can be compensated without affecting the existing link aggregation mechanism.

In an embodiment of the disclosure, compensating the asymmetry may comprise, when the first network device receives a first PTP event message via the first LAG member from the second network device, updating a correction field of the first PTP event message based on the delay value of the first LAG member. Compensating the asymmetry may further comprise, when the first network device is to send a second PTP event message via the second LAG member to the second network device, updating a correction field of the second PTP event message based on the delay value of the second LAG member.

In an embodiment of the disclosure, the correction field of the first PTP event message may be updated by adding the delay value of the first LAG member to an original value of the correction field of the first PTP event message. The correction field of the second PTP event message may be updated by adding the delay value of the second LAG member to an original value of the correction field of the second PTP event message.

In an embodiment of the disclosure, compensating the asymmetry may comprise determining an offset between a slave clock of the first network device and a master clock of the second network device, based on the PTP messages, the delay value of the first LAG member and the delay value of the second LAG member.

In an embodiment of the disclosure, the offset may be determined as a sum of: an original offset determined based on timestamps related to the PTP messages; and a half of a difference between the delay value of the second LAG member and the delay value of the first LAG member.

In an embodiment of the disclosure, the first LAG member may be every LAG member of the LAG for which the delay value has not been determined. Obtaining the delay value for the first LAG member may comprise, when the first network device receives a first PTP event message via the every LAG member from the second network device, determining a propagation delay of the every LAG member based on PTP timestamps related to the first PTP event message. Obtaining the delay value for the first LAG member may further comprise determining the delay value for the every LAG member based on the determined propagation delay of the every LAG member.

In an embodiment of the disclosure, obtaining the delay value for the first LAG member may comprise maintaining a delay record containing the delay value determined for the every LAG member.

In an embodiment of the disclosure, the delay record may contain an indicator indicating, for each LAG member of the LAG, whether a delay value has been determined for the LAG member.

In an embodiment of the disclosure, the second LAG member may be each LAG member of the LAG for which a state of the delay value changes from “having not been determined” to “having been determined”.

In an embodiment of the disclosure, a second PTP event message having the same content may be sent respectively via the each LAG member from the first network device to the second network device.

In an embodiment of the disclosure, obtaining the delay value for the first LAG member may comprise, when the first network device receives a first PTP event message via the first LAG member from the second network device, reading, from a delay record containing at least one delay value previously determined for at least one LAG member of the LAG, a delay value corresponding to the first LAG member.

In an embodiment of the disclosure, obtaining the delay value for the second LAG member may comprise, when the first network device is to send a second PTP event message via the second LAG member to the second network device, reading, from a delay record containing at least one delay value previously determined for at least one LAG member of the LAG, a delay value corresponding to the second LAG member.

In an embodiment of the disclosure, the reference LAG member may be an LAG member having the smallest propagation delay among LAG members of the LAG.

In an embodiment of the disclosure, the reference LAG member may be any of the LAG members of the LAG.

In an embodiment of the disclosure, the first PTP event message may be a Sync message, and the second PTP event message may be a Delay Request message.

According to a second aspect of the disclosure, there is provided a method performed by a second network device. There is an LAG between a first network device acting as a PTP slave and the second network device acting as a PTP master. The method may comprise maintaining a delay record containing, for each LAG member of the LAG, an indicator indicating whether a propagation delay has been determined for the LAG member. The method may further comprise sending at least one PTP message to the first network device based on the delay record.

In this way, it is possible to compensate the delay asymmetry due to the path change caused by the LAG.

In an embodiment of the disclosure, sending at least one PTP message to the first network device based on the delay record may comprise sending, for every LAG member of the LAG for which a propagation delay has not been determined, a first PTP event message having the same content respectively via the every LAG member to the first network device.

In an embodiment of the disclosure, the first PTP event message may be a Sync message.

In an embodiment of the disclosure, maintaining the delay record may comprise, when receiving a second PTP event message from the first network device via at least one of the every LAG member, changing the indicator for the at least one LAG member from indicating “not having been determined” to indicating “having been determined”.

In an embodiment of the disclosure, the second PTP event message may be a Delay Request message.

According to a third aspect of the disclosure, there is provided a method performed by a second network device. There may be an LAG between a first network device acting as a PTP slave and the second network device acting as a PTP master. The method may comprise obtaining, for a first LAG member of the LAG acting as a first path from the PTP master to the PTP slave in an exchange of PTP messages for clock synchronization, a delay value reflecting an additional propagation delay of the first LAG member relative to a reference LAG member of the LAG. The method may further comprise obtaining, for a second LAG member of the LAG acting as a second path from the PTP slave to the PTP master in the exchange of the PTP messages, a delay value reflecting an additional propagation delay of the second LAG member relative to the reference LAG member. The method may further comprise compensating an asymmetry between propagation delays of the first path and the second path, based on the delay value of the first LAG member and the delay value of the second LAG member.

In this way, it is possible to compensate the delay asymmetry due to the path change caused by the LAG.

In an embodiment of the disclosure, compensating the asymmetry may comprise, when the second network device is to send a first PTP event message via the first LAG member to the first network device, updating a correction field of the first PTP event message based on the delay value of the first LAG member. Compensating the asymmetry may further comprise, when the second network device receives a second PTP event message via the second LAG member from the first network device and is to send a response message in response to the received second PTP event message, updating a correction field of the response message based on the delay value of the second LAG member.

In an embodiment of the disclosure, the correction field of the first PTP event message may be updated by adding the delay value of the first LAG member to an original value of the correction field of the first PTP event message. The correction field of the response message may be updated by adding the delay value of the second LAG member to an original value of the correction field of the response message.

According to a fourth aspect of the disclosure, there is provided a first network device. There is an LAG between the first network device acting as a PTP slave and a second network device acting as a PTP master. The first network device may comprise at least one processor and at least one memory. The at least one memory may contain instructions executable by the at least one processor, whereby the first network device may be operative to obtain, for a first LAG member of the LAG acting as a first path from the PTP master to the PTP slave in an exchange of PTP messages for clock synchronization, a delay value reflecting an additional propagation delay of the first LAG member relative to a reference LAG member of the LAG. The first network device may be further operative to obtain, for a second LAG member of the LAG acting as a second path from the PTP slave to the PTP master in the exchange of the PTP messages, a delay value reflecting an additional propagation delay of the second LAG member relative to the reference LAG member. The first network device may be further operative to compensate an asymmetry between propagation delays of the first path and the second path, based on the delay value of the first LAG member and the delay value of the second LAG member.

In an embodiment of the disclosure, the first network device may be operative to perform the method according to the above first aspect.

According to a fifth aspect of the disclosure, there is provided a second network device. There is an LAG between a first network device acting as a PTP slave and the second network device acting as a PTP master. The second network device may comprise at least one processor and at least one memory. The at least one memory may contain instructions executable by the at least one processor, whereby the second network device may be operative to maintain a delay record containing, for each LAG member of the LAG, an indicator indicating whether a propagation delay has been determined for the LAG member. The second network device may be further operative to send at least one PTP message to the first network device based on the delay record.

In an embodiment of the disclosure, the second network device may be operative to perform the method according to the above second aspect.

According to a sixth aspect of the disclosure, there is provided a second network device. There is an LAG between a first network device acting as a PTP slave and the second network device acting as a PTP master. The second network device may comprise at least one processor and at least one memory. The at least one memory may contain instructions executable by the at least one processor, whereby the second network device may be operative to obtain, for a first LAG member of the LAG acting as a first path from the PTP master to the PTP slave in an exchange of PTP messages for clock synchronization, a delay value reflecting an additional propagation delay of the first LAG member relative to a reference LAG member of the LAG. The second network device may be further operative to obtain, for a second LAG member of the LAG acting as a second path from the PTP slave to the PTP master in the exchange of the PTP messages, a delay value reflecting an additional propagation delay of the second LAG member relative to the reference LAG member. The second network device may be further operative to compensate an asymmetry between propagation delays of the first path and the second path, based on the delay value of the first LAG member and the delay value of the second LAG member.

In an embodiment of the disclosure, the second network device may be operative to perform the method according to the above third aspect.

According to a seventh aspect of the disclosure, there is provided a computer program product. The computer program product may contain instructions which when executed by at least one processor, cause the at least one processor to perform the method according to any of the above first to third aspects.

According to an eighth aspect of the disclosure, there is provided a computer readable storage medium. The computer readable storage medium may store thereon instructions which when executed by at least one processor, cause the at least one processor to perform the method according to any of the above first to third aspects.

According to a ninth aspect of the disclosure, there is provided a first network device. There is an LAG between the first network device acting as a PTP slave and a second network device acting as a PTP master. The first network device may comprise a first obtaining module for obtaining, for a first LAG member of the LAG acting as a first path from the PTP master to the PTP slave in an exchange of PTP messages for clock synchronization, a delay value reflecting an additional propagation delay of the first LAG member relative to a reference LAG member of the LAG. The first network device may further comprise a second obtaining module for obtaining, for a second LAG member of the LAG acting as a second path from the PTP slave to the PTP master in the exchange of the PTP messages, a delay value reflecting an additional propagation delay of the second LAG member relative to the reference LAG member. The first network device may further comprise a compensation module for compensating an asymmetry between propagation delays of the first path and the second path, based on the delay value of the first LAG member and the delay value of the second LAG member.

According to a tenth aspect of the disclosure, there is provided a second network device. There is an LAG between a first network device acting as a PTP slave and the second network device acting as a PTP master. The second network device may comprise a maintaining module for maintaining a delay record containing, for each LAG member of the LAG, an indicator indicating whether a propagation delay has been determined for the LAG member. The second network device may further comprise a sending module for sending at least one PTP message to the first network device based on the delay record.

According to an eleventh aspect of the disclosure, there is provided a second network device. There is an LAG between a first network device acting as a PTP slave and the second network device acting as a PTP master. The second network device may comprise a first obtaining module for obtaining, for a first LAG member of the LAG acting as a first path from the PTP master to the PTP slave in an exchange of PTP messages for clock synchronization, a delay value reflecting an additional propagation delay of the first LAG member relative to a reference LAG member of the LAG. The second network device may further comprise a second obtaining module for obtaining, for a second LAG member of the LAG acting as a second path from the PTP slave to the PTP master in the exchange of the PTP messages, a delay value reflecting an additional propagation delay of the second LAG member relative to the reference LAG member. The second network device may further comprise a compensation module for compensating an asymmetry between propagation delays of the first path and the second path, based on the delay value of the first LAG member and the delay value of the second LAG member.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating a PTP message exchange procedure;

FIG. 2 is a diagram illustrating a scenario of PTP over LAG;

FIG. 3 is a diagram illustrating another scenario of PTP over LAG;

FIG. 4 is a flowchart illustrating a method performed by a first network device according to an embodiment of the disclosure;

FIGS. 5A-5B are flowcharts for explaining the method of FIG. 4;

FIG. 6 is a diagram for explaining the method of FIG. 4;

FIG. 7 is another diagram for explaining the method of FIG. 4;

FIG. 8 is a flowchart for explaining the method of FIG. 4;

FIGS. 9A-9B are flowcharts for explaining the method of FIG. 4;

FIG. 10A is a flowchart illustrating a method performed by a second network device according to an embodiment of the disclosure;

FIG. 10B is a flowchart for explaining the method of FIG. 10A;

FIG. 11A is a flowchart illustrating a method performed by a second network device according to an embodiment of the disclosure;

FIG. 11B is a flowchart for explaining the method of FIG. 11A;

FIG. 12 is a block diagram showing an apparatus suitable for use in practicing some embodiments of the disclosure;

FIG. 13 is a block diagram showing a first network device according to an embodiment of the disclosure;

FIG. 14A is a block diagram showing a second network device according to an embodiment of the disclosure;

FIG. 14B is a block diagram showing a second network device according to an embodiment of the disclosure;

FIG. 15 is a block diagram illustrating the packet receiving architecture of a first network device according to an embodiment;

FIG. 16 is a flowchart illustrating a method performed by the packet receiving architecture of FIG. 15;

FIG. 17 is a block diagram illustrating the packet sending architecture of a first network device according to an embodiment;

FIG. 18 is a flowchart illustrating a method performed by the packet sending architecture of FIG. 17;

FIG. 19 is a flowchart illustrating a packet sending method performed by a second network device according to an embodiment; and

FIG. 20 is a flowchart illustrating a packet receiving method performed by a second network device according to an embodiment.

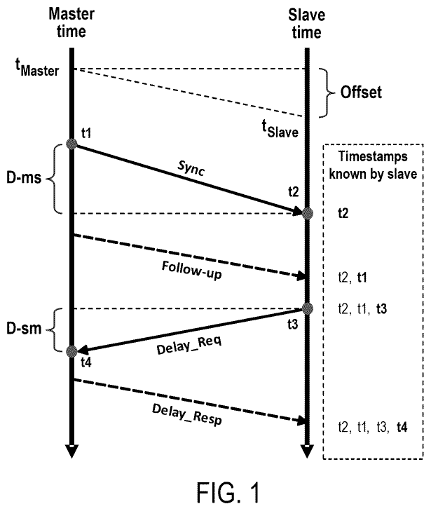

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

Plenty of mechanisms, which are applied in traffic network to make the traffic network more efficient, are not considering this specific packet-based mechanism. For example, diversity resiliency mechanism (e.g., LAG) would cause path consistency (or path asymmetry) issues.

LAG, known as link aggregation group, introduced a method of link aggregation to provide Ethernet resiliency by combining (aggregating) multiple network links in parallel. This combined links increase throughput beyond what a single link could sustain, and provide redundancy in case one of the links fails. The combined links are formed as a link aggregation group. Combined link interfaces share one physical address (i.e., medium access control (MAC) address). Load balance is used to balance the traffic load among the combined links. Each packet/stream is mapped to a specific link via applying a hash algorithm based on the Destination-MAC address. The details introducing about the link aggregation is defined in “IEEE802.3-Link Aggregation Segments”.

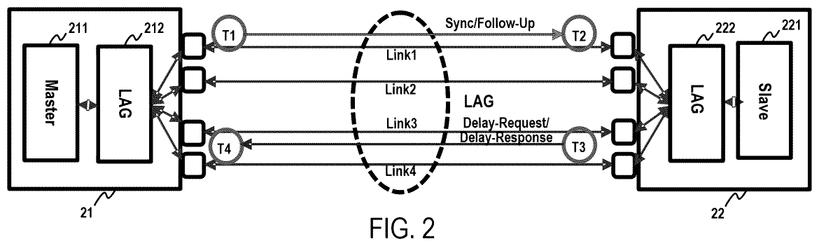

FIG. 2 illustrates a first scenario of PTP over LAG. As shown, between a master device 21 and a slave device 22, Link 1 to Link 4 are combined as a link aggregation group. The master device has a master module 211 and an LAG module 212. The slave device has a slave module 221 and an LAG module 222. Different link has different line length, connection media, etc. So, the delays introduced by the links are different. Master generates a Sync message with timestamp T1 (carried by a “two-step” Follow-Up message) and sends to Slave via link 1, and Slave generates timestamp T2 once the Sync message arrives at Slave. Then, Slave generates a Delay-Request message with timestamp T3 (reserved by Slave) and sends to Master via link 3. Once the Delay-Request message arrives at Master, timestamp T4 is generated.

In the first scenario, load balance is used to balance the traffic load among the link aggregation. So, the messages from Master and Slave will be balanced to different links randomly. That will cause the delay values to be changed all the time, and this changing is caused by the special mechanism. This typical Ethernet resiliency method will involve PTP path asymmetry issue, eventually affecting the PTP performance.

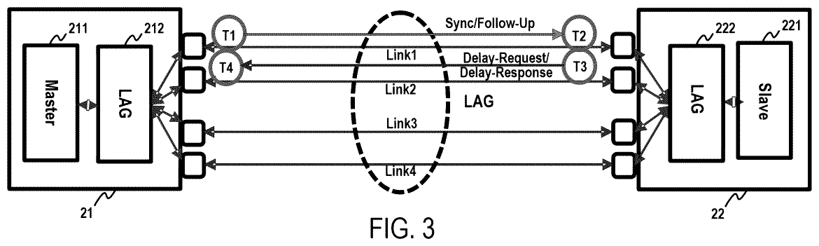

FIG. 3 illustrates a second scenario of PTP over LAG. As shown, similar to FIG. 2, between the master device 21 and the slave device 22, Link 1 to Link 4 are combined as a link aggregation group. Different link has different line length, connection media, etc. So, the delays introduced by the links are different. Master generates a Sync message with timestamp T1 (carried by a “two-step” Follow-Up message) and sends to Slave via link 1, and Slave generates timestamp T2 once the Sync message arrives at Slave. Slave generates a Delay-Request message with timestamp T3 (reserved by Slave) and sends to Master via link 1 controllably. Once the Delay-Request message arrives at Master, timestamp T4 is generated.

In the second scenario, link redundancy is used to provide redundancy in case one of the links fails among the link aggregation. So, the messages from Master and Slave will be migrated to other links randomly. That will cause the delay values to be changed, and this changing is caused by the special mechanism. For example, once link 1 is broken, all the PTP messages should be migrated to other links, such as link 2. If link 2 has big delay difference with link 1, the migration of the messages will cause the same impact to the algorithm according to the rates of the messages. Thus, in the second scenario, this typical Ethernet resiliency method will also involve PTP path delay change issue, eventually affecting the PTP performance.

The common solution to solve the path consistency issue is to use the same physical path on both Master and Slave side. Based on the specific packet-based mechanism of PTP (the Sync/Follow-Up packets rate may be different than the Delay-Request/Delay-Response packets rate), it will be complex to identify the unique physical path for both packets. And the common solution will ignore the traffic load balance and link redundancy functions provide by link aggregation. If there are many PTP packet streams, this common solution may face the bandwidth issues. Therefore, it would be advantageous to provide a mechanism to solve the path consistency issue without affecting the existing link aggregation mechanism.

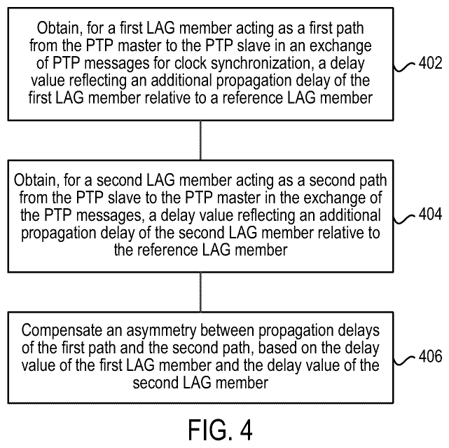

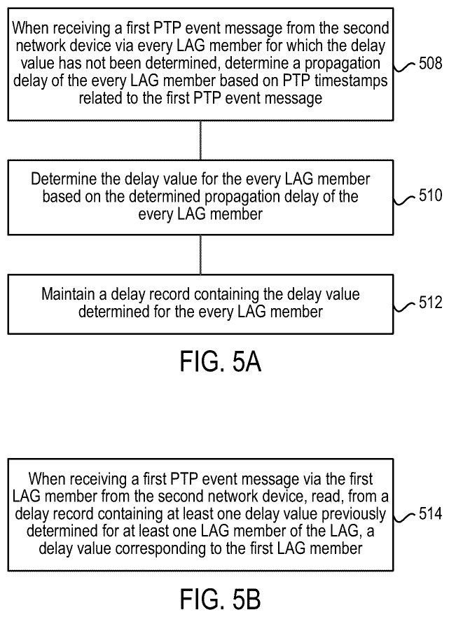

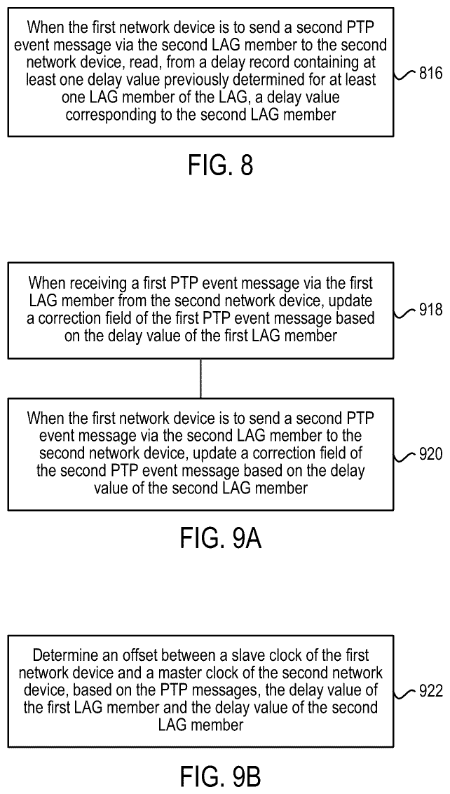

The present disclosure proposes an improved solution for PTP clock synchronization. The solution may be applicable to any network device which supports LAG and PTP functions at the same time. Examples of the network device include, but not limited to, a switch, a router, a baseband device, a radio equipment, and the like. The network device may also be a “multiple services network device” that provides support for multiple networking functions (e.g., switching, routing, bridging, Layer 2 aggregation, session border control, quality of service, and/or subscriber management), and/or provides support for multiple application services (e.g., data, voice, and video). When carrying out PTP clock synchronization, the network device may act as any one of a telecom boundary clock (T-BC), a partial-support telecom boundary clock (T-BC-P), an assisted partial-support telecom boundary clock (T-BC-A), a partial-support telecom time slave clock (T-TSC-P), an assisted partial-support telecom time slave clock (T-TSC-A), and the like. Hereinafter, the solution will be described in detail with reference to FIGS. 4-20.

FIG. 4 is a flowchart illustrating a method performed by a first network device according to an embodiment of the disclosure. The method may be applicable to an environment in which there is an LAG between the first network device acting as a PTP slave and a second network device acting as a PTP master. At block 402, the first network device obtains, for a first LAG member of the LAG acting as a first path from the PTP master to the PTP slave in an exchange of PTP messages for clock synchronization, a delay value reflecting an additional propagation delay of the first LAG member relative to a reference LAG member of the LAG. For example, if one-step mode is used, the PTP messages for clock synchronization may include a Sync message, a Delay Request message and a Delay Response message. If two-step mode is used, the PTP messages for clock synchronization may include a Sync message, a Follow-up message, a Delay Request message and a Delay Response message.

For example, the first LAG member may refer to the LAG member(s) via which a first PTP event message (e.g. a Sync message) is received by the first network device from the second network device. In a first case where there are LAG member(s) for which the delay value has not been determined, every such LAG member may be determined as the first LAG member by the second network device, which will be described later. As an exemplary example, if the delay values of all the LAG members of the LAG are initially unknown to the first network device, the first LAG member may be every LAG member of the LAG. For the first case, block 402 may be implemented as blocks 508-512.

At block 508, when the first network device receives a first PTP event message from the second network device via every LAG member for which the delay value has not been determined, the first network device determines a propagation delay of the every LAG member based on PTP timestamps related to the first PTP event message. For example, the PTP timestamps related to the first PTP event message (e.g. a Sync message) may include a first timestamp at which the first PTP event message is sent from the second network device, and a second timestamp at which the first PTP event message is received by the first network device. Depending on whether one-step mode or two-step mode is used, the second timestamp may be carried by the first PTP event message or a Follow-up message. The propagation delay of the every LAG member may be determined as the difference between the second timestamp and the first timestamp.

At block 510, the first network device determines the delay value for the every LAG member based on the determined propagation delay of the every LAG member. As an example, the reference LAG member may be an LAG member having the smallest propagation delay among LAG members of the LAG. Then, the delay value for the every LAG member may be determined as the difference between the determined propagation delay of the every LAG member and the propagation delay of the reference LAG member. As another example, according to the above equation (4), if the additional propagation delay of the first path is subtracted from the propagation delay (t2−t1) of the first path, and the additional delay of the second path is subtracted from the propagation delay (t4−t3) of the second path, then the asymmetry between the two propagation delays can be compensated. Since the Offset equals to the difference between the two propagation delays, only the difference between the two additional propagation delays needs to be calculated for making the compensation. Thus, any one of the LAG members of the LAG may act as the reference LAG member. Then, the delay value for the every LAG member may be determined as the difference between the determined propagation delay of the every LAG member and the propagation delay of the reference LAG member. Note that the delay value is not limited to the difference determined in the above two examples, as long as the delay value can reflect the additional propagation delay of the given LAG member relative to the reference LAG member. For instance, a sum of the difference determined in either of the above two examples and a predetermined fixed value may also be used as the delay value.

At block 512, the first network device maintains a delay record containing the delay value determined for the every LAG member. As an example, the delay record may at least contain, for the every LAG member, an index of the LAG member and the delay value of the LAG member. As another example, the delay record may contain, for the every LAG member, an index of the LAG member, the delay value of the LAG member, and the propagation delay of the LAG member. As still another example, the delay record may contain an indicator indicating, for each LAG member of the LAG, whether a delay value has been determined for the LAG member.

Referring back to block 402, in a second case where there is no LAG member for which the delay value has not be determined, the first LAG member may be an LAG member selected according to link aggregation mechanism. For the second case, block 402 may be implemented as block 514. At block 514, when the first network device receives a first PTP event message via the first LAG member from the second network device, the first network device reads, from a delay record containing at least one delay value previously determined for at least one LAG member of the LAG, a delay value corresponding to the first LAG member.

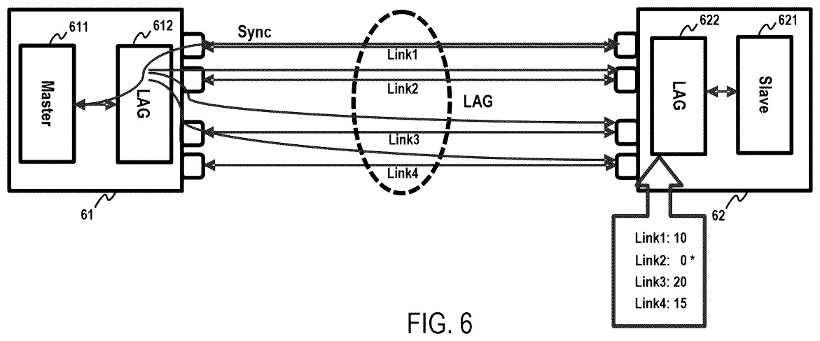

For ease of understanding, the scenario shown in FIG. 6 is taken as an example for explaining the obtaining of the delay value of the first LAG member. As shown, between a master device 61 and a slave device 62, Link 1 to Link 4 are combined as a link aggregation group. The master device 61 has a master module 611 and an LAG module 612. The slave device 62 has a slave module 621 and an LAG module 622. Suppose that different link has different line length, connection media, etc. So, the delays introduced by the links are different. Also suppose that at the beginning, the four links are in “not-ready” state (corresponding to “having not been determined” described above) for all PTP event messages. The “not-ready” state means that if the link state is “not-ready” state, that will block Delay-Request messages pass through the link.

The first Sync message is triggered at Master side. When the message arrives at an LAG port, because all the LAG members of the LAG is in “not-ready” state, the Sync message is duplicated and sent at all the links with the state “not-ready” at the same time. Then, when the Sync messages arrive at SLAVE side, the received timestamps t2 are generated. For example, Link 1 generates t2′, Link 2 generates t2″, etc. The timestamp t1 may be carried by the Sync messages (in one-step mode) or the subsequent Follow-up message. The propagation delays of respective LAG members may be calculated as the differences between respective timestamps (t2′, t2″, . . . ) and the timestamp t1. All the propagation delays may be compared with the smallest propagation delay which is the reference of all the propagation delays. The delay differences may be calculated and stored in a table called “path delay record” maintained in the Slave side, where the index of the table is the link port. In the example shown in FIG. 6, Link 2 has the smallest propagation delay and thus it is selected as the reference link whose delay difference is zero. The correctionFileds of the Sync messages may be updated with the delay values in the “path delay record”, which will be described later. Note that the first link member (Link 1) of the LAG or any other link member may be used as the reference link instead, as described above. If there is a valid delay difference for a link, the link may be changed into “ready” state. Then, Delay-Request messages can pass through the link.

Then, a Delay-Request message passes from the Slave side. Suppose that the states of all the LAG members of the LAG change from “not-ready” to “ready”. Then, when the Delay-Request message arrives at an LAG port, the Delay-Request message is duplicated. The correctionFileds of these Delay-Request messages may be updated with the delay values in the “path delay record”, which will be described later. Then, these Delay-Request messages are sent via all the links with the state “ready”.

When the Delay-Request messages arrive at the Master side, the state of all the links are set to “ready” by the Master side. The subsequent Sync message will only be duplicated for the “not-ready” link. When the subsequent Sync message arrives at the Slave side, the corrrectionFiled of the message may be updated with the delay values in the “path delay record”, which will be described later.

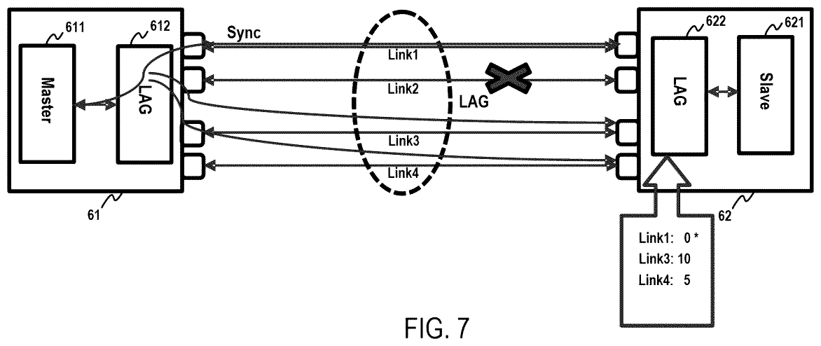

FIG. 7 illustrates another scenario in which Link 2 is removed from the link aggregation group. In this case, the process described above with respect to FIG. 6 may be performed again to calculate the delay differences. The difference between the processes of FIGS. 6 and 7 only lies in that duplicated Sync messages are sent via the other three links (Link 1, Link 3, Link 4) in FIG. 7. As a result, the “Link Delay Table” is refreshed as the link 1 then becomes the reference of the other links. The delay value of each link is updated according to Link 1 as shown in FIG. 7. Alternatively, when Link 2 is removed, it is also possible that the “Link Delay Table” is updated based on previously calculated propagation delays without performing again the process described above with respect to FIG. 6. It should be noted that in the examples shown in FIGS. 6 and 7, Slave side is merely used as an example for the calculation of delay values. It is also possible for the delay values to be calculated at Master side.

Referring back to FIG. 4, at block 404, the first network device obtains, for a second LAG member of the LAG acting as a second path from the PTP slave to the PTP master in the exchange of the PTP messages, a delay value reflecting an additional propagation delay of the second LAG member relative to the reference LAG member. For example, the second LAG member may refer to the LAG member(s) via which a second PTP event message (e.g. a Delay Request message) is to be sent from the first network device to the second network device. In the above first case where there are LAG member(s) for which the delay value has not been determined, each LAG member of the LAG for which a state of the delay value changes from “having not been determined” to “having been determined” may be determined as the second LAG member by the first network device. For the first case, a second PTP event message having the same content may be sent respectively via the each LAG member from the first network device to the second network device. In the above second case where there is no LAG member for which the delay value has not be determined, the second LAG member may be an LAG member selected according to link aggregation mechanism. For both cases described above, block 404 may be implemented as block 816. At block 816, when the first network device is to send a second PTP event message via the second LAG member to the second network device, the first network device reads, from a delay record containing at least one delay value previously determined for at least one LAG member of the LAG, a delay value corresponding to the second LAG member.

It should be noted that the obtaining of the delay values of the first and second LAG members is not limited to the examples described above. As another example, without using the timestamps related to the first PTP event message, the propagation delay of each LAG member of the LAG may be estimated initially as a product of the average propagation delay per unit length and the length of the LAG member. Then, the delay value of each LAG member may be calculated as a difference between the estimated propagation delay of the LAG member and the estimated propagation delay of the reference LAG member. As yet another example, any other existing or future developed techniques may be used to get the propagation delays of the LAG members.

At block 406, the first network device compensates an asymmetry between propagation delays of the first path and the second path, based on the delay value of the first LAG member and the delay value of the second LAG member. As a first option, block 406 may be implemented as blocks 918-920. At block 918, when the first network device receives a first PTP event message via the first LAG member from the second network device, the first network device updates a correction field of the first PTP event message based on the delay value of the first LAG member. The correction field of a PTP message is used for recording and accumulating the residence time of the PTP message in transparent clock(s) along the path between the master and slave devices. More details about the correction field can be obtained from IEEE 1588 2008, “IEEE Standard for a Precision Clock Synchronization Protocol for Networked Measurement and Control Systems” (e.g. section 13.3.2.7). For example, the correction field of the first PTP event message may be updated by adding the delay value of the first LAG member to an original value of the correction field of the first PTP event message. At block 920, when the first network device is to send a second PTP event message via the second LAG member to the second network device, the first network device updates a correction field of the second PTP event message based on the delay value of the second LAG member. For example, the correction field of the second PTP event message may be updated by adding the delay value of the second LAG member to an original value of the correction field of the second PTP event message.

According to “11.2 Computation of clock offset in ordinary and boundary clocks” and “11.3 Delay request-response mechanism” of “IEEE 1588-2008”, in the case where one-step mode is used, e.g. if the received first PTP event message (e.g. a Sync message) indicates that a Follow_Up message will not be received (e.g. the twoStepFlag bit of the flagField of the Sync message is FALSE), <meanPathDelay> (corresponding to the Delay in the above equation (3)) and <offsetFromMaster> (corresponding to the Offset in the above equation (4)) shall be computed as:

$$〈 meanPathDelay 〉 = [ ( t 2 - t 3 ) + ( receiveTimestamp of Delay\_Resp message - originTimestamp of Sync message ) - correctionField of Sync message - correctionField of Delay\_Resp message ] / 2 , \qquad ( 5 )$$

$$〈 offsetFromMaster 〉 = 〈 syncEventIngressTimestamp 〉 - 〈 originTimestamp 〉 - 〈 meanPathDelay 〉 - correctionField of Sync message . \qquad ( 6 )$$

Because the delay value of the first path is accumulated into the correction filed of the first PTP event message (e.g. the Sync message) and the delay value of the second path is accumulated into the correction field of the second PTP event message (e.g. the Delay Request message) and thus also accumulated into the correction field of the Delay Response message, the delay asymmetry can be compensated in the above calculation of <meanPathDelay>. Similarly, because the delay value of the first path is accumulated into the correction filed of the first PTP event message (e.g. the Sync message), the additional propagation delay of the first path can be compensated in the above calculation of <offsetFromMaster>. As a result, the asymmetry can be compensated without affecting the existing link aggregation mechanism and the existing calculation formula of the offset.

According to “11.2 Computation of clock offset in ordinary and boundary clocks” and “11.3 Delay request-response mechanism” of “IEEE 1588-2008”, in the case where two-step mode is used, e.g. if the received first PTP event message (e.g. a Sync message) indicates that a Follow_Up message will be received (e.g. the twoStepFlag bit of the flagField of the Sync message is TRUE), <meanPathDelay> (corresponding to the Delay in the above equation (3)) and <offsetFromMaster> (corresponding to the Offset in the above equation (4)) shall be computed as:

$$〈 meanPathDelay 〉 = [ ( t 2 - t 3 ) + ( receiveTimestamp of Delay\_Resp message - preciseOriginTimestamp of Follow\_Up message ) - correctionField of Sync message - correctionField of Follow\_Up message - correctionField of Delay\_Resp message ] / 2 , \qquad ( 7 )$$

$$〈 offsetFromMaster 〉 = 〈 syncEventIngressTimestamp 〉 - 〈 preciseOriginTimestamp 〉 - 〈 meanPathDelay 〉 - correctionField of Sync message - correctionField of Follow\_Up message . \qquad ( 8 )$$

Because the delay value of the first path is accumulated into the correction filed of the first PTP event message (e.g. the Sync message) and the delay value of the second path is accumulated into the correction field of the second PTP event message (e.g. the Delay Request message) and thus also accumulated into the correction field of the Delay Response message, the delay asymmetry can be compensated in the above calculation of <meanPathDelay>. Similarly, because the delay value of the first path is accumulated into the correction filed of the first PTP event message (e.g. the Sync message), the additional propagation delay of the first path can be compensated in the above calculation of <offsetFromMaster>. As a result, the asymmetry can also be compensated without affecting the existing link aggregation mechanism and the existing calculation formula of the offset.

Note that the present disclosure is not limited to the first option described above with respect to block 406. As a second option, block 406 may be implemented as block 922. At block 922, the first network device determines an offset between a slave clock of the first network device and a master clock of the second network device, based on the PTP messages, the delay value of the first LAG member and the delay value of the second LAG member. For example, the offset may be determined as a sum of: an original offset determined based on timestamps related to the PTP messages; and a half of a difference between the delay value of the second LAG member and the delay value of the first LAG member. This may be expressed as:

$$Offset = original offset + ( the delay value of the second LAG member - the delay value of the first LAG member ) / 2. \qquad ( 9 )$$

The original offset may be determined by using four timestamps t1˜t4 related to the PTP messages and the original values of correction fields of related PTP messages. Thus, in the second option, the values of the correction fields are not updated based on the delay values of the first and second LAG members. Depending on whether one-step mode or two-step mode is used, the above equation (6) or (8) may be used for determining the original offset. For example, after every first PTP event message is received, its related timestamps t1 and t2 as well as the delay value of the corresponding first LAG member may be recorded. In addition, after every second PTP event message is sent, its related timestamps t3 and t4 as well as the delay value of the corresponding second LAG member may be recorded. Then, the recorded delay values of the first and second LAG members may be retrieved to determine the offset according to equation (9) so as to make the compensation.

For ease of understanding, the above equation (4) is used for explaining the compensation. According to equation (4), if the delay value of the first path is subtracted from (t2−t1) and the delay value of the second path is subtracted from (t4−t3), then the delay asymmetry can be compensated. This means that the delay asymmetry can be compensated by adding, to the original offset, a half of the difference between the delay value of the second LAG member and the delay value of the first LAG member. Thus, with the second option, although the calculation formula of the offset is changed, the asymmetry can also be compensated without affecting the existing link aggregation mechanism.

As an exemplary example, in the scenario shown in FIG. 6, suppose that the delay values of all LAG members of the LAG have been known by the Slave. Then, Master generates a Sync message with timestamp t1 (which may be carried by a “two-step” Follow-Up message) and sends it to Slave. When receiving the Sync message, Slave updates the “correctionFiled” of the Sync message by using the delay value of the current link and generates timestamp t2. For example, if the Sync message arrives at Slave via Link 1, then the “correctionFiled” is updated by “new correctionFiled=old correctionFiled+10”. If the Sync message arrives via Link 2, then the “correctionFiled” is updated by “new correctionFiled=old correctionFiled+0”. The same holds true for Link 3 or Link 4.

Then, Slave generates a Delay-Request message with timestamp t3 (reserved by Slave) and updates the “correctionFiled” of the Delay-Request message by using the delay value of the link selected according to link aggregation mechanism. Then, Slave sends it to Master via the selected link. For example, if the Delay-Request message is sent to master via Link 3, then the “correctionFiled” of the Delay-Request message is updated by “new correctionFiled=old correctionFiled+20”. If the Delay-Request message is sent to master via Link 2, the “correctionFiled” of the Delay-Request message is updated by “new correctionFiled=old correctionFiled+0”. The same holds true for Link 3 or Link 4.

Once the Delay-Request message arrives at Master, timestamp T4 is generated and sent within a Delay-Response message to Slave. According to the current IEEE standard, the “correctionFiled” of the Delay-Request message is accumulated into the “correctionFiled” of the Delay-Response message.

According to the analysis provided above with respect to block 406, the <meanPathDelay> values are almost the same when passing through different link members. And after all, the <offsetFromMaster> values are almost the same, too. Thus, the LAG can balance PTP messages on the link members randomly. And even one link member is lost, the messages sent via other links will not be affected by the link delay changing.

Thus, the first and second network devices can transfer the PTP messages via random LAG member according to the LAG load balance function but without any PTP clock performance effect. Even if a link failure happens and other link(s) are selected for the PTP messages to pass through according to the link redundancy function of the LAG, the PTP clock performance can be still stable.

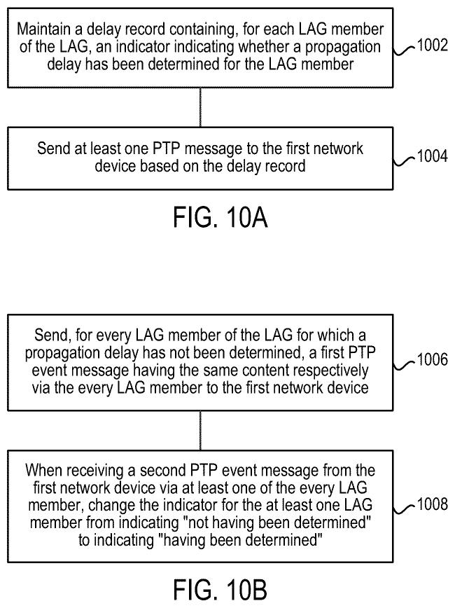

FIG. 10A is a flowchart illustrating a method performed by a second network device according to an embodiment of the disclosure. The method may be applicable to an environment in which there is an LAG between a first network device acting as a PTP slave and the second network device acting as a PTP master. At block 1002, the second network device maintains a delay record containing, for each LAG member of the LAG, an indicator indicating whether a propagation delay has been determined for the LAG member. For example, the delay record may contain, for each LAG member, an index of the LAG member and the indicator for the LAG member. At block 1004, the second network device sends at least one PTP message to the first network device based on the delay record. With the method of FIG. 10A, it is possible to compensate the delay asymmetry due to the path change caused by the LAG.

For example, in a case where there are LAG member(s) for which a propagation delay has not been determined (e.g. the propagation delays of all the LAG members of the LAG may be unknown initially), block 1004 may be implemented as block 1006 of FIG. 10B. At block 1006, the second network device sends, for every LAG member of the LAG for which a propagation delay has not been determined, a first PTP event message (e.g. a Sync message) having the same content respectively via the every LAG member to the first network device. In this way, the first network device can be allowed to determine the propagation delay for the every LAG member according to timestamps related to the first PTP event message, thereby making it possible to compensate the delay asymmetry due to the path change caused by the LAG.

As described above, at the side of the first network device, for each LAG member of the LAG for which a state of the delay value changes from “having not been determined” to “having been determined”, a second PTP event message (e.g. a Delay Request message) having the same content may be sent respectively via the each LAG member from the first network device to the second network device. In this case, block 1002 may be implemented as block 1008 of FIG. 10B. At block 1008, when receiving a second PTP event message from the first network device via at least one of the every LAG member, the second network device changes the indicator for the at least one LAG member from indicating “not having been determined” to indicating “having been determined”. In this way, the state of the at least one LAG member can be updated, so that there is no need for the second network device to dedicatedly send again a first PTP event message via the at least one LAG member for determining the propagation delay.

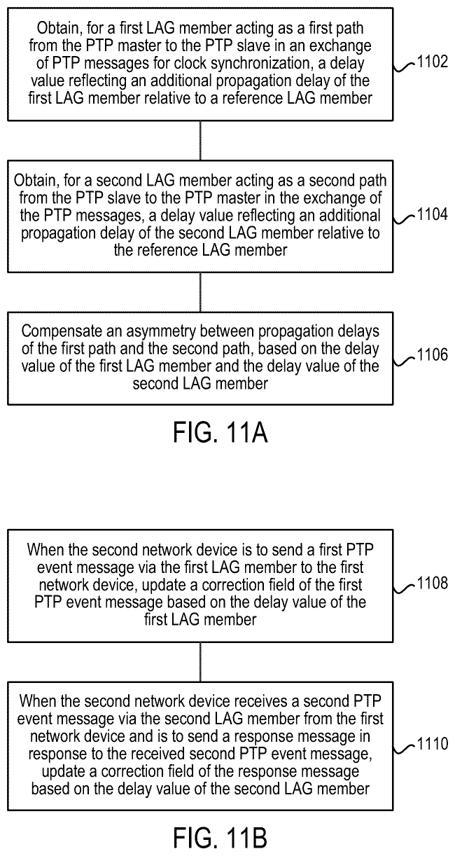

FIG. 11A is a flowchart illustrating a method performed by a second network device according to an embodiment of the disclosure. The method may be applicable to an environment in which there is an LAG between a first network device acting as a PTP slave and the second network device acting as a PTP master. The main difference between the methods of FIG. 4 and FIG. 11A lies in that the compensation of the delay asymmetry is performed by the PTP master instead of the PTP slave. At block 1102, the second network device obtains, for a first LAG member of the LAG acting as a first path from the PTP master to the PTP slave in an exchange of PTP messages for clock synchronization, a delay value reflecting an additional propagation delay of the first LAG member relative to a reference LAG member of the LAG. At block 1104, the second network device obtains, for a second LAG member of the LAG acting as a second path from the PTP slave to the PTP master in the exchange of the PTP messages, a delay value reflecting an additional propagation delay of the second LAG member relative to the reference LAG member.

For instance, for each LAG member, the second network device may send a second PTP event message (e.g. a Delay Request message) to the first network device, so that the propagation delay of the LAG member may be determined by the second network device based on the timestamps (e.g. timestamps t3 and t4) related to the second PTP event message (e.g. determined as a difference between t4 and t3). Then, the delay value of each LAG member may be determined and maintained in a way similar to blocks 510 and 512.

At block 1106, the second network device compensates an asymmetry between propagation delays of the first path and the second path, based on the delay value of the first LAG member and the delay value of the second LAG member. For instance, block 1106 may be implemented as blocks 1108-1110 of FIG. 11B. At block 1108, when the second network device is to send a first PTP event message (e.g. a Sync message) via the first LAG member to the first network device, the second network device updates a correction field of the first PTP event message based on the delay value of the first LAG member. For example, the correction field of the first PTP event message may be updated by adding the delay value of the first LAG member to an original value of the correction field of the first PTP event message. At block 1110, when the second network device receives a second PTP event message (e.g. a Delay Request message) via the second LAG member from the first network device and is to send a response message (e.g. a Delay Response message) in response to the received second PTP event message, the second network device updates a correction field of the response message based on the delay value of the second LAG member. For example, the correction field of the response message may be updated by adding the delay value of the second LAG member to an original value of the correction field of the response message. As a result, the same compensation effect can be achieved. Note that after the delay values of all the LAG members of the LAG have been determined and maintained by the second terminal device, the first LAG member or the second LAG member may be selected according to link aggregation mechanism.

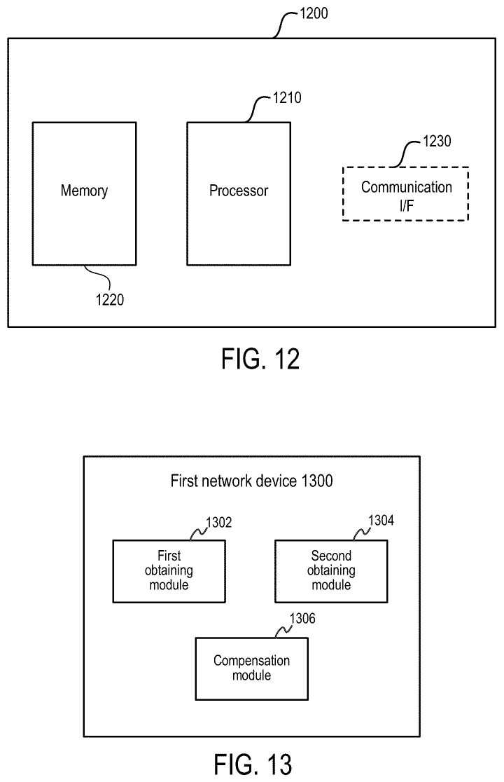

FIG. 12 is a block diagram showing an apparatus suitable for use in practicing some embodiments of the disclosure. For example, any of the first network device and the second network device described above may be implemented through the apparatus 1200. As shown, the apparatus 1200 may include a processor 1210, a memory 1220 that stores a program, and optionally a communication interface 1230 for communicating data with other external devices through wired and/or wireless communication.

The program includes program instructions that, when executed by the processor 1210, enable the apparatus 1200 to operate in accordance with the embodiments of the present disclosure, as discussed above. That is, the embodiments of the present disclosure may be implemented at least in part by computer software executable by the processor 1210, or by hardware, or by a combination of software and hardware.

The memory 1220 may be of any type suitable to the local technical environment and may be implemented using any suitable data storage technology, such as semiconductor based memory devices, flash memories, magnetic memory devices and systems, optical memory devices and systems, fixed memories and removable memories. The processor 1210 may be of any type suitable to the local technical environment, and may include one or more of general purpose computers, special purpose computers, microprocessors, digital signal processors (DSPs) and processors based on multi-core processor architectures, as non-limiting examples.

FIG. 13 is a block diagram showing a first network device according to an embodiment of the disclosure. The first network device may be applicable to an environment in which there is an LAG between the first network device acting as a PTP slave and a second network device acting as a PTP master. As shown, the first network device 1300 comprises a first obtaining module 1302, a second obtaining module 1304 and a compensation module 1306. The first obtaining module 1302 may be configured to obtain, for a first LAG member of the LAG acting as a first path from the PTP master to the PTP slave in an exchange of PTP messages for clock synchronization, a delay value reflecting an additional propagation delay of the first LAG member relative to a reference LAG member of the LAG, as described above with respect to block 402. The second obtaining module 1304 may be configured to obtain, for a second LAG member of the LAG acting as a second path from the PTP slave to the PTP master in the exchange of the PTP messages, a delay value reflecting an additional propagation delay of the second LAG member relative to the reference LAG member, as described above with respect to block 404. The compensation module 1306 may be configured to compensate an asymmetry between propagation delays of the first path and the second path, based on the delay value of the first LAG member and the delay value of the second LAG member, as described above with respect to block 406.

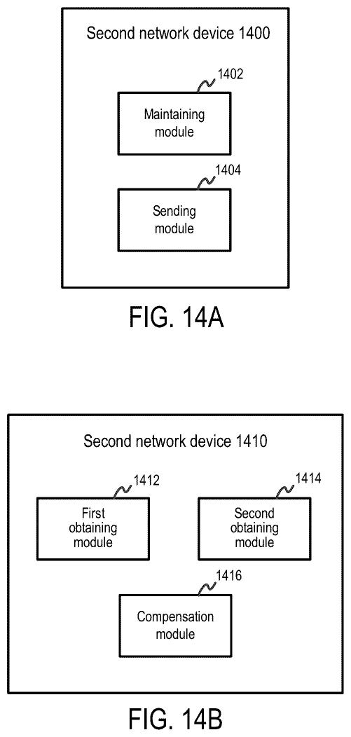

FIG. 14A is a block diagram showing a second network device according to an embodiment of the disclosure. The second network device may be applicable to an environment in which there is an LAG between a first network device acting as a PTP slave and the second network device acting as a PTP master. As shown, the second network device 1400 comprises a maintaining module 1402 and a sending module 1404. The maintaining module 1402 may be configured to maintain a delay record containing, for each LAG member of the LAG, an indicator indicating whether a propagation delay has been determined for the LAG member, as described above with respect to block 1002. The sending module 1404 may be configured to sending at least one PTP message to the first network device based on the delay record, as described above with respect to block 1004.

FIG. 14B is a block diagram showing a second network device according to an embodiment of the disclosure. The second network device may be applicable to an environment in which there is an LAG between a first network device acting as a PTP slave and the second network device acting as a PTP master. As shown, the second network device 1410 comprises a first obtaining module 1412, a second obtaining module 1414 and a compensation module 1416. The first obtaining module 1412 may be configured to obtain, for a first LAG member of the LAG acting as a first path from the PTP master to the PTP slave in an exchange of PTP messages for clock synchronization, a delay value reflecting an additional propagation delay of the first LAG member relative to a reference LAG member of the LAG. The second obtaining module 1414 may be configured to obtain, for a second LAG member of the LAG acting as a second path from the PTP slave to the PTP master in the exchange of the PTP messages, a delay value reflecting an additional propagation delay of the second LAG member relative to the reference LAG member. The compensation module 1416 may be configured to compensate an asymmetry between propagation delays of the first path and the second path, based on the delay value of the first LAG member and the delay value of the second LAG member. The modules described above may be implemented by hardware, or software, or a combination of both.

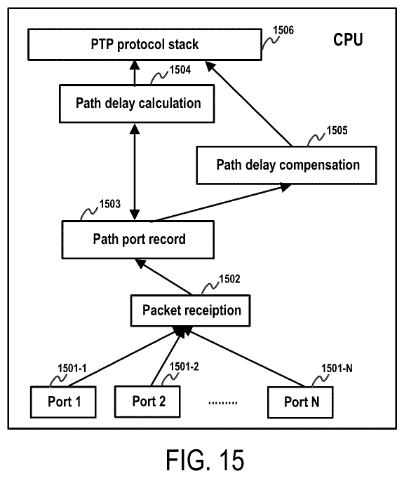

FIG. 15 is a block diagram illustrating the packet receiving architecture of a first network device according to an embodiment. As shown, the packet receiving architecture of the first network device comprises ports 1501-1˜1501-N, a packet reception module 1502, a path port record module 1503, a path delay calculation module 1504, a path delay compensation module 1505, and a PTP protocol stack 1506. The modules 1503, 1504 and 1505 are new modules introduced by the embodiment. In this embodiment, the first obtaining module described above is implemented as the path port record module 1503 and the path delay calculation module 1504. The second obtaining module described above is implemented as the path port record module 1503. The compensation module described above is implemented as the path delay compensation module 1505.

The path port record module 1503 may store the indexes of the LAG members and store the LAG member state “not-ready” (corresponding to “having not been determined” described above) or “ready” (corresponding to “having been determined” described above) for each LAG member. The path port record module 1503 may also trigger the path delay calculation module 1504 to run when receiving Sync messages at the SLAVE side, and store the delay difference of each LAG member (relative to the reference LAG member) in a “Link Delay Table” at SLAVE side.

The path delay calculation module 1504 is implemented at SLAVE side. It may be triggered by the path port record module 1502 to calculate the delay value with (e.g. duplicated) Sync messages once the Sync messages (and optionally Follow-up messages) arrive, and store the delay value into the path port record module 1502 with the LAG member index. The path delay compensation module 1505 is implemented at SLAVE side. It may be based on the path port record module 1502. For the received Sync messages, the path delay compensation module 1505 may update the correctionField as “new correctionField=old correctionField+delay value”.

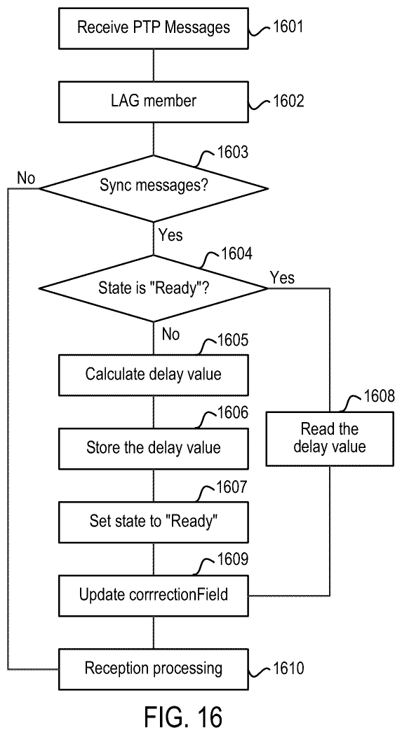

FIG. 16 is a flowchart illustrating a method performed by the packet receiving architecture of FIG. 15. Steps 1603-1609 are new steps introduced by the embodiment. At step 1601, the link port receives PTP messages including Sync and Delay-Request. At step 1602, the PTP messages pass through the LAG member. At step 1603, it is determined whether the message is Sync. If the message is not Sync, the process goes to step 1610 where normal reception processing is performed. On the other hand, if the message is Sync, the process goes to step 1604.

At step 1604, the path port record module is checked to see whether the state of the LAG member is “Ready”. If the state is “Not-Ready”, then the process moves to step 1605. At step 1605, the path delay calculation module calculates the delay value of the LAG member. Then, at step 1606, the calculation result is stored if the delay value for the link is valid. At step 1607, the link state of the LAG member is set to “Ready” in the path port record module. Then, at step 1609, the path delay compensation module updates the correctionField of Sync message with formula “new correctionField=old correctionField+delay value”. Then, at step 1610, normal reception processing is performed.

On the other hand, if the state of the LAG member is “Ready”, the process goes to step 1608. At step 1608, the corresponding delay value is read with the link number. Then, after the updating of the correctionField at step 1609, normal reception processing is performed at step 1610.

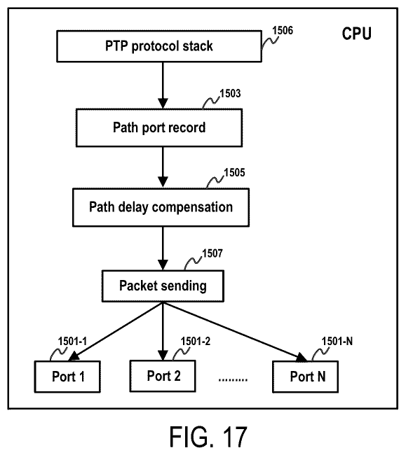

FIG. 17 is a block diagram illustrating the packet sending architecture of a first network device according to an embodiment. As shown, the packet sending architecture of the first network device comprises the ports 1501-1˜1501-N, a packet sending module 1507, the path delay compensation module 1505, the path port record module 1503, and the PTP protocol stack 1506. The modules 1505 and 1503 are new modules introduced by the embodiment. In addition to the functions described above with respect to FIG. 15, the path port record module 1503 may trigger duplication of Delay Request message and send them via corresponding (e.g. all) LAG members at SLAVE side. In addition to the functions described above with respect to FIG. 15, the path delay compensation module 1505 may update, for to-be-sent Delay-Request messages, the correctionField as “new correctionField=old correctionField+delay value”.

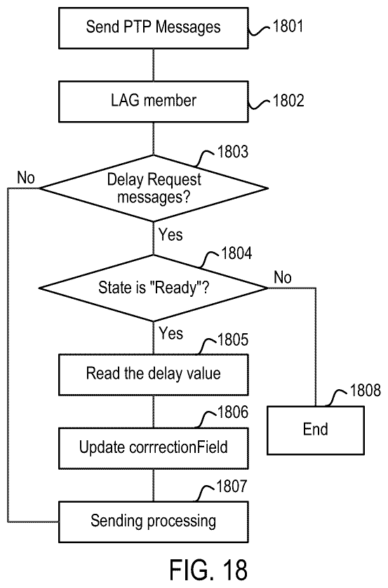

FIG. 18 is a flowchart illustrating a method performed by the packet sending architecture of FIG. 17. Steps 1803-1806 are new steps introduced by the embodiment. At step 1801, the PTP protocol stack is to send PTP messages including Sync and Delay-Request. At step 1802, the PTP messages pass through the LAG member. At step 1803, it is determined whether the message is Delay-Request. If the message is not Delay-Request, the process goes to step 1807 where normal sending (or transmission) processing is performed. On the other hand, if the message is Delay-Request, the process goes to step 1804.

At step 1804, the path port record module is checked to see whether the state of the link member is “Ready”. If the state of the link member is not “Ready”, the process will end. On the other hand, if the state of the link member is “Ready”, the process moves to step 1805. At step 1805, the corresponding delay value is read from the path port record module via the link number. At step 1806, the path delay compensation module updates the correctionField of the Delay-Request with the formula “new correctionField=old correctionField+delay value”. Then, normal sending processing is performed to send the message out. Note that if the states of the current LAG member and one or more additional LAG member changes from “Not-Ready” to “Ready”, the Delay-Request for the current LAG member may be duplicated to be also sent on the one or more additional LAG member.

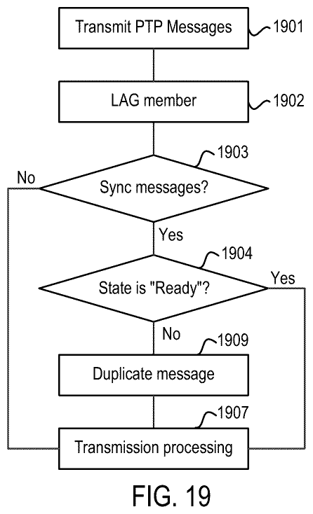

FIG. 19 is a flowchart illustrating a packet sending method performed by a second network device according to an embodiment. Steps 1903, 1904 and 1909 are new steps introduced by the embodiment. In this embodiment, the maintaining module described above may be implemented as a path port record module. The path port record module may store the indexes of the LAG members and store the LAG member state “not-ready” (corresponding to “having not been determined” described above) or “ready” (corresponding to “having been determined” described above) for each LAG member. The path port record module may also trigger the duplication of Sync message and send them via corresponding (e.g. all) LAG members at MASTER side. The duplication may be performed by the sending module described above.

At step 1901, the PTP protocol stack is to send PTP messages including Sync and Delay-Request. At step 1902, the PTP messages pass through the LAG member. At step 1903, it is determined whether the message is Sync. If the message is not Sync, the process goes to step 1907 where normal sending (or transmission) processing is performed. On the other hand, if the message is Sync, the process goes to step 1904.

At step 1904, the path port record module is checked to see whether the state of the link member is “Ready”. If the state of the link member is “Ready”, the process goes to step 1907 where normal sending (or transmission) processing is performed. On the other hand, if the state of the link member is not “Ready”, the process moves to step 1909. At step 1909, the Sync message is duplicated. Here, it is assumed that there is additional LAG member whose state is also “Not-Ready”. Note that step 1909 may be omitted if the current LAG member is the only LAG member whose state is “Not-Ready”. Alternatively, as long as the state of the current LAG member is “Not-Ready”, the Sync message may be duplicated to be sent on another LAG member whose state is “Ready”. By using the another LAG member as a reference, the delay difference of the current LAG member relative to this reference may be determined. Then, at step 1907, normal sending (or transmission) processing is performed to send the message out.

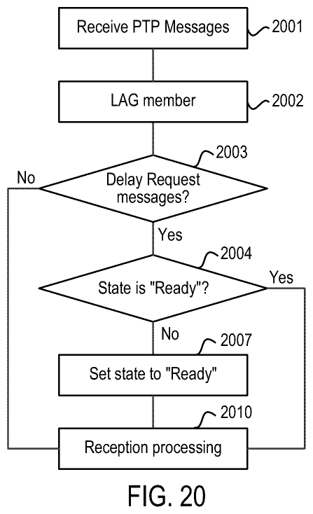

FIG. 20 is a flowchart illustrating a packet receiving method performed by a second network device according to an embodiment. Steps 2003, 2004 and 2007 are new steps introduced by the embodiment. Similar to FIG. 19, in this embodiment, the maintaining module described above may be implemented as a path port record module. At step 2001, the link port receives PTP messages including Sync and Delay-Request. At step 2002, the PTP messages pass through the LAG member. At step 2003, it is determined whether the message is Delay-Request. If the message is not Delay-Request, the process goes to step 2010 where normal reception processing is performed. On the other hand, if the message is Delay-Request, the process goes to step 2004.

At step 2004, the path port record module is checked to see whether the state of the LAG member is “Ready”. If the state is “Ready”, then the process moves to step 2010 where normal reception processing is performed. On the other hand, if the state is “Not-Ready”, then the process moves to step 2007. At step 2007, the link state of the LAG member is set to “Ready” in the path port record module. Then, at step 2010, normal reception processing is performed.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a first network device, wherein there is a link aggregation group, LAG, between the first network device acting as a precision time protocol, PTP, slave and a second network device acting as a PTP master, the method comprising:
obtaining, for a first LAG member of the LAG acting as a first path from the PTP master to the PTP slave in an exchange of PTP messages for clock synchronization, a delay value reflecting an additional propagation delay of the first LAG member relative to a reference LAG member of the LAG;
obtaining, for a second LAG member of the LAG acting as a second path from the PTP slave to the PTP master in the exchange of the PTP messages, a delay value reflecting an additional propagation delay of the second LAG member relative to the reference LAG member; and
compensating an asymmetry between propagation delays of the first path and the second path, based on the delay value of the first LAG member and the delay value of the second LAG member.

2. The method according to claim 1, wherein compensating the asymmetry comprises:
when the first network device receives a first PTP event message via the first LAG member from the second network device, updating a correction field of the first PTP event message based on the delay value of the first LAG member; and
when the first network device is to send a second PTP event message via the second LAG member to the second network device, updating a correction field of the second PTP event message based on the delay value of the second LAG member.

3. The method according to claim 2, wherein the correction field of the first PTP event message is updated by adding the delay value of the first LAG member to an original value of the correction field of the first PTP event message; and
wherein the correction field of the second PTP event message is updated by adding the delay value of the second LAG member to an original value of the correction field of the second PTP event message.

4. The method according to claim 1, wherein compensating the asymmetry comprises:
determining an offset between a slave clock of the first network device and a master clock of the second network device, based on the PTP messages, the delay value of the first LAG member and the delay value of the second LAG member.

5. The method according to claim 4, wherein the offset is determined as a sum of:
an original offset determined based on timestamps related to the PTP messages; and
a half of a difference between the delay value of the second LAG member and the delay value of the first LAG member.

6. The method according to claim 1, wherein the first LAG member is every LAG member of the LAG for which the delay value has not been determined; and
wherein obtaining the delay value for the first LAG member comprises:
when the first network device receives a first PTP event message via the every LAG member from the second network device, determining a propagation delay of the every LAG member based on PTP timestamps related to the first PTP event message; and
determining the delay value for the every LAG member based on the determined propagation delay of the every LAG member.

7. The method according to claim 6, wherein obtaining the delay value for the first LAG member comprises:
maintaining a delay record containing the delay value determined for the every LAG member.

8. The method according to claim 7, wherein the delay record contains an indicator indicating, for each LAG member of the LAG, whether a delay value has been determined for the LAG member.

9. The method according to claim 6, wherein the second LAG member is each LAG member of the LAG for which a state of the delay value changes from “having not been determined” to “having been determined”.

10. The method according to claim 9, wherein a second PTP event message having the same content is sent respectively via the each LAG member from the first network device to the second network device.

11. The method according to claim 1, wherein obtaining the delay value for the first LAG member comprises:
when the first network device receives a first PTP event message via the first LAG member from the second network device, reading, from a delay record containing at least one delay value previously determined for at least one LAG member of the LAG, a delay value corresponding to the first LAG member.

12. The method according to claim 1, wherein obtaining the delay value for the second LAG member comprises:
when the first network device is to send a second PTP event message via the second LAG member to the second network device, reading, from a delay record containing at least one delay value previously determined for at least one LAG member of the LAG, a delay value corresponding to the second LAG member.

13. The method according to claim 1, wherein the reference LAG member is an LAG member having the smallest propagation delay among LAG members of the LAG; or
wherein the reference LAG member is any of the LAG members of the LAG.

14. The method according to claim 2,
wherein the first PTP event message is a Sync message, and the second PTP event message is a Delay Request message.

15-19. (canceled)

20. A first network device, wherein there is a link aggregation group, LAG, between the first network device acting as a precision time protocol, PTP, slave and a second network device acting as a PTP master, the first network device comprising:
at least one processor; and
at least one memory, the at least one memory containing instructions executable by the at least one processor, whereby the first network device is operative to:
obtain, for a first LAG member of the LAG acting as a first path from the PTP master to the PTP slave in an exchange of PTP messages for clock synchronization, a delay value reflecting an additional propagation delay of the first LAG member relative to a reference LAG member of the LAG;
obtain, for a second LAG member of the LAG acting as a second path from the PTP slave to the PTP master in the exchange of the PTP messages, a delay value reflecting an additional propagation delay of the second LAG member relative to the reference LAG member; and
compensate an asymmetry between propagation delays of the first path and the second path, based on the delay value of the first LAG member and the delay value of the second LAG member.

21-23. (canceled)

24. A method performed by a second network device, wherein there is a link aggregation group, LAG, between a first network device acting as a precision time protocol, PTP, slave and the second network device acting as a PTP master, the method comprising:
obtaining, for a first LAG member of the LAG acting as a first path from the PTP master to the PTP slave in an exchange of PTP messages for clock synchronization, a delay value reflecting an additional propagation delay of the first LAG member relative to a reference LAG member of the LAG;
obtaining, for a second LAG member of the LAG acting as a second path from the PTP slave to the PTP master in the exchange of the PTP messages, a delay value reflecting an additional propagation delay of the second LAG member relative to the reference LAG member; and
compensating an asymmetry between propagation delays of the first path and the second path, based on the delay value of the first LAG member and the delay value of the second LAG member.

25. The method according to claim 24, wherein compensating the asymmetry comprises:
when the second network device is to send a first PTP event message via the first LAG member to the first network device, updating a correction field of the first PTP event message based on the delay value of the first LAG member; and
when the second network device receives a second PTP event message via the second LAG member from the first network device and is to send a response message in response to the received second PTP event message, updating a correction field of the response message based on the delay value of the second LAG member.

26. The method according to claim 25, wherein the correction field of the first PTP event message is updated by adding the delay value of the first LAG member to an original value of the correction field of the first PTP event message; and
wherein the correction field of the response message is updated by adding the delay value of the second LAG member to an original value of the correction field of the response message.

27-28. (canceled)

29. A computer readable storage medium storing thereon instructions which when executed by at least one processor, cause the at least one processor to perform the method according to claim 1.

30. A computer readable storage medium storing thereon instructions which when executed by at least one processor, cause the at least one processor to perform the method according to claim 24.
